(19) United States
(12) Patent Application Publication
(10) Pub. No.: US 2006/0173389 A1
(43) Pub. Date: Aug. 3, 2006

(54) Reflex massager

(76) Inventor: David Chai, Santa Clara, CA (US)

Correspondence Address: David Chai, 1157 East River Parkway, Santa Clara, CA, 95054, US

(21) Appl. No.: 11/048,978

(22) Filed: Feb. 3, 2005

(51) Int. Cl. A61H 7/00

(52) U.S. Cl. 601/135; 601/137

(57) ABSTRACT

The REFLEX MASSAGER is a plastic hand-held, non-electric, massager for the human body. The massager consists of a handle with massaging balls attached by flexible spring coils to the ends of the handle/base unit. The massaging balls of the massager comes in contact with the skin and are rolled all over the body to provide a deep, powerful massage.

### SUMMARY OF INVENTION

I, David Chai, am submitting a utility patent for the REFLEX MASSAGER. The REFLEX MASSAGER is a hand-held massaging device that can be used on any part(s) of the human body. The REFLEX MASSAGERS unique flexible/hinged massaging balls are spring mounted to the massager base/handle and provides forward and backward as well as side to side motion as the REFLEX MASSAGER is moved across the body. Slight downward pressure on the massager caused the springs to flex and push the massaging balls outwards. Releasing the downward pressure causes the springs to straighten and the massaging balls to come back inwards. Same action and reaction occurs when side to side motion is applied with the up and down motion. This creates a unique kneading action that one would experience from an actual hand massage. Therefore, the REFLEX MASSAGER provides a more realistic human hand massage feeling versus the non-flexible hand-held massagers where the massaging balls are stiffly attached to the base/handle of the massager. The spring coils can be rubber or plastics coated for comfort and/or safety. Also, the spring coils can be replaced with other types of flexible hinge to achieve the same results.

### SPECIFICATION/DESCRIPTION

The flexible spring coils of the REFLEX MASSAGER allow the massaging balls a range of motion semi-independent to the motion and direction of the base massager (handle) to which the massaging balls and spring coils are attached.

Slight downward pressure on the base will cause the springs to flex, hence, pushing the massaging balls outwards. Releasing the downward pressure will result in the springs returning to its original straight form and causes the massaging balls to move inwards. Similar side to side motions of the REFLEX MASSAGER, along with the up and down pressure put on the massaging base/handle by the user, will create similar actions/movements of the massaging balls.

This semi-independent motion of the massaging balls, due to its flexible attachment to the base/handle, along with the movement of the base/handle by the user, creates a kneading action similar to the feel of a human hand massage. This feeling cannot be accomplished with a hand-held massager in which the massaging balls are firmly fixed to the base/handle. The REFLEX MASSAGER (with the massaging balls attached to a flexible attachment) provides two ranges of motion (1-massaging balls, 2-base/handle) where as a hand-held massager with the massaging balls firmly attached to the base/handle provides only one range of motion (1-base/handle).

### FIGURE DESCRIPTION

FIG. 1 shows a top view of the REFLEX MASSAGER There are three parts to the massager. 1) The plastic massage balls, 2) flexible spring coils, and 3) the plastic base/handle of the massager are clearly labeled. The flexible spring coils are attached to the ends of the massage base/handle. The plastic massage balls are attached to the other ends of the spring coils.

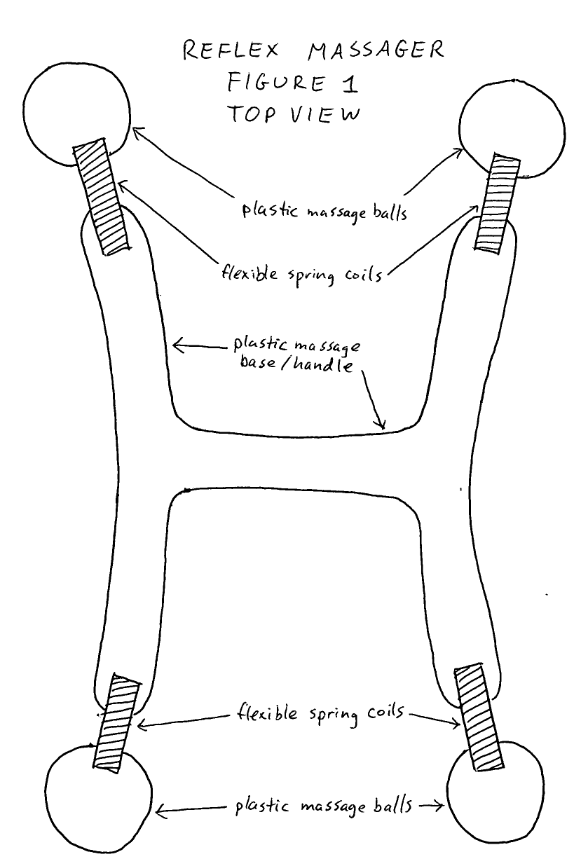

Figure 2 shows a side elevated view of the REFLEX MASSAGER.

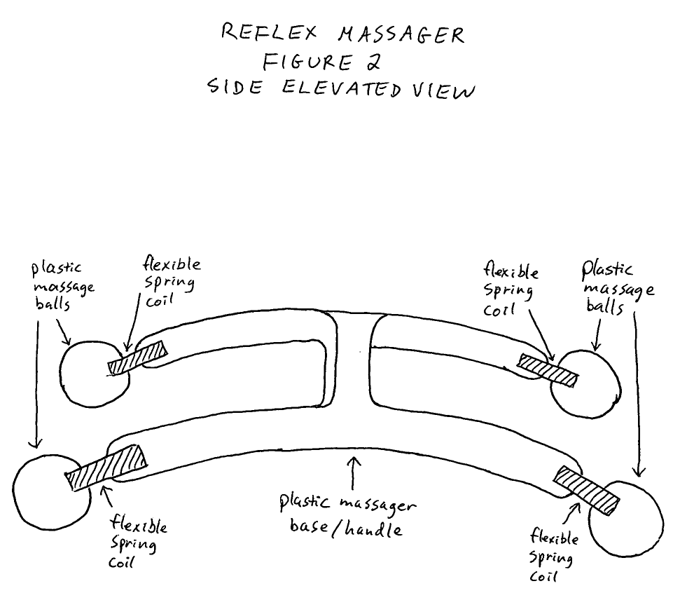

What is claimed is:

1. A hand-held massaging device comprising: a plastic hand-held massager (base/handle); flexible spring coils (or other flexible materials that can serve the same purpose) attached to the ends of the massager base/handle; plastic massaging balls attached to the spring coils. The REFLEX MASSAGER is made by 1) attaching the spring coils to the ends of the plastic massage base/handle and 2) attaching the plastic massage balls to the other end of the spring coils.
